(19) United States
(12) Patent Application Publication
(10) Pub. No.: US 2016/0262420 A1
(43) Pub. Date: Sep. 15, 2016

(54) DISPOSITION INTRODUCED IN AUTOMATED EQUIPMENT FOR THE PRODUCTION OF ICE CREAM

(71) Applicant: FINAMAC LLC, Miami, FL (US)

(72) Inventor: Marino Arpino, Santo André - SP (BR)

(21) Appl. No.: 15/016,194

(22) Filed: Feb. 4, 2016

(30) Foreign Application Priority Data
Mar. 11, 2015 (BR) 202015053865

(51) Int. Cl. A23G 9/22

(52) U.S. Cl. CPC A23G 9/222; A23G 9/224

(57) ABSTRACT

DISPOSITION INTRODUCED IN AUTOMATED EQUIPMENT FOR THE PRODUCTION OF ICE CREAM, belonging to the field of foodstuff equipment is idealized as an automatic equipment for production of “soft” ice cream (1), which is formed from a casing (2) with a vertical rectangular prismatic geometry and has a single ice cream output, in which there is a shape swivel (19), which changes the shape of the ice cream output, that can extract two flavors of ice cream, separately or mixed, and add flavored syrup to the ice cream.

### FIELD OF APPLICATION

The object of this utility model patent is a practical and innovative model of equipment for the production of “soft” ice cream, belonging to the field of foodstuff equipment. More precisely these are refinements in an automatic machine for obtaining “soft” ice cream to which was given an original constructive disposition. These refinements improve the machines use and performance in relation to the other models usually found in the market.

“Soft” ice cream is an aerated ice cream usually served in cup containers or preferably in edible containers specifically conformed to this end. The most common container has a conical shape and the same composition as the “waffle”, made of flour and eggs.

The object of the patent is an equipment specially designed and developed to be very convenient and that brings great benefits both in its use and in its manufacture.

It is also the objective of this request to submit a model of equipment for the production of “soft” ice cream with low costs for industrial feasibility, while meeting the requirements of robustness, security and convenience, thus offering the consumer an additional option in the market of counterparts that, unlike the usual models, offers numerous versatilities and benefits to their users, becoming a model of great acceptance in the consumer market.

### BACKGROUND OF THE INVENTION

The “soft” ice cream is an ice cream produced in real time, in front of the client, and a great advantage when comparing to other types of ice cream is that it can be served in several places other than ice cream parlors and indoor establishments.

The user does not require knowledge of ice cream recipes because “soft” ice cream mixtures can be found ready on the market. The “soft” ice cream machine can also make acai ice cream, yoghurt ice cream, milk shakes and slushies.

The machine does not require a specialized operator, facilitating the implementation of the equipment in all types of venues and not only in food establishments.

Many “soft” ice cream machines are installed on the sidewalks of streets with great movement, mainly in the most central areas of cities.

The usual machines have two containers, each containing a flavor, which keep the “soft” ice cream mixtures chilled. From the containers the mixtures are conducted to two cylinders, one for each flavor, where they are mixed and frozen to become “soft” ice cream and then extracted as separate flavors or as mixed flavor through valves actuated by handles in front of the machine.

### THE STATE OF THE ART

The great inconvenience from “soft” ice cream machines is the fact that the same concepts have been used for decades. The basic model has three handles aligned in the front panel. The side handles each serve a different flavor and the central serves both flavors mixed.

Even with the evolution of the electronic part of the machine the functions available and basic operation remain the same.

The state of the art never changed the traditional design in the form of a “box” and the constructive pattern remained the same, which is a metal structure covered by folded sheet metal.

### SUMMARY OF THE INVENTION

Considering these deficiencies the inventor, a person connected to the field, after extensive research and studies, created and developed the object of this patent. The inventor envisioned an automatic equipment for the production of “soft” ice cream considering not only the mechanical and functional qualities in its manufacture design, but also the form, the arrangement and the position of its parts and components, increasing the efficiency without creating any burden.

Thus, the patent was engineered to obtain a product with the smallest number of parts possible, conveniently configured and arranged to allow the automatic equipment for production of ice cream to perform its functions with efficiency and unparalleled versatility, without the disadvantages mentioned beforehand.

This patent request presents a practical and innovative model of automatic equipment for production of ice cream with aesthetic and functional qualities, designed and developed in accordance with the most modern techniques, allowing the production of ice cream in various shapes, in addition to various other innovations. The ice cream produced in this equipment will be completely different from conventional “soft” ice cream that is only served as a spiral and in only two flavors or mixed.

Its innovative design allows the machine to obtain an excellent level of functionality, offering a model of automatic equipment for production of ice cream that has great durability, created mainly to be able to make a greater diversity of “soft” ice cream and with better quality, while presenting an appreciable innovative design.

The configuration of the equipment, object of this patent, incorporates several innovations in its new constructive form as indicated below:

Ice Cream Air Incorporation System

The air embedded in ice cream provides greater softness and is the main characteristic and differential of the “soft” ice cream. The quantity of air incorporated in ice cream varies from 30% of volume overrun on machines that do not have an air injection pump up to 70% of volume overrun on machines that do. The machine developed is capable of incorporating air above 100% of volume overrun. This means that for each liter of mixture the machine can make up to two liters of quality ice cream, resulting in higher profitability.

Variety of Ice Cream Shapes

The state of the art “soft” ice cream exits the machine in a contorted star shape, forming an ice cream cone on the cone or cup where it is served.

The automatic equipment for production of ice cream developed allows the customer to choose different shapes for the extraction of ice cream such as noodles, star, square, sliced in thin blades etc. Hence, it is possible to obtain various tridimensional shapes of ice cream by choosing the extraction shape and moving the ice cream container properly as the ice cream is extracted from the valve of the equipment.

New Ice Cream Decoration

The automatic equipment for production of ice cream can be equipped with an injector of colorful flavored syrup fillets, which accompany the design of ice cream. This technique enables the coloring of the product with one of four different flavored syrups. In conventional machines, these fillets may only be added to a single ice cream flavor that the machine makes, but the machine proposed can make any combination of ice cream flavor and syrup flavor. The machine can for example extract green mint syrup on a mixed vanilla and chocolate ice cream, only on vanilla ice cream or only on chocolate ice cream, without the need to change the mechanisms position.

Conventional equipments require the installation of the syrup fillets device on the output of the desired flavor, i.e. strawberry syrup can only be extracted with vanilla ice cream. The syrup installed on one ice cream output cannot be easily changed to another output. The proposed machine will not have this limitation.

New Ice Cream Mixing System

In conventional “soft” ice cream machines, the product is mixed quickly because the product needs to be served right away. This results in an ice cream with small ice crystals that change its texture and a non-homogeneous air distribution inside the ice cream, making it less creamy.

The automatic equipment for production of ice cream has a mixing system in which the ice cream passes through a duct and is mixed with air. In addition, several blades where carefully designed to smoothly scrape the ice cream off the freezing cylinder while creating a homogeneous mix between mixture and air.

Innovative System of Containers for the Preparation, Heating and Cooling of the Ice Cream Mixture

The automatic equipment for production of ice cream has two independent containers at its upper part that can prepare, heat and cool the ice cream mixture, ensuring its full pasteurization.

Within the containers there is an innovative agitation system that forces the mixture to pass through an apparatus to cool or warm it up. In conventional machines, cooling is made through the walls of the containers, but this causes the formation of ice, especially when they are not completely full, with consequent melting and change in the composition of the mixture. In the proposed automatic equipment for production of ice cream, the cooling and heating of the mixture is performed by the aforementioned apparatus immersed in each container, eliminating completely the problem of ice formation. The mixture stays in constant agitation at the right temperature to start production, while avoiding the separation of ingredients from the mixture.

The machines can be equipped with a water spray in its interior, with drainage on the rear of the machine to facilitate the cleaning process.

Container Cover

Designed with curves and inclinations, the cover of the containers of the automatic equipment for production of ice cream prevents the drops of moisture that form in its surface from dripping inside the mixture and channels them around the container, though a channel that leads to the rear of the machine.

In conventional machines, the covers of the containers are flat and the moisture formed in their surface drips inside the mixture changing its composition along the day.

In addition, the new cover of the automatic equipment for production of ice cream can be protected with thermal insulation for warm places or places with partial sunlight incidence.

Without Handles

There are no handles for the extraction of ice cream. It is possible to adjust the flow of ice cream and the desired extraction time. More specifically, the operator, after regulating these two parameters, can extract a cone or cup by pressing a button on the machine. The machine then extracts the regulated amount of ice cream, in enough time for the operator to move the ice cream cone or cup and fill it while decorating the ice cream.

This is done manually on conventional machines, pulling handles that extract the ice cream, but the amount extracted is defined by the operator, so there is no repeatability on the extraction. The time of decoration is also dependent on the operator. In the proposed automatic equipment for production of ice cream the operator can repeat each operation of ice cream extraction and decoration with the same quantity and duration.

Cones and Cup Holders

In conventional machines, it is necessary to purchase additional equipment to accommodate Sundae cups and ice cream cones for “soft” ice cream. Such equipment serves as dispensers of these containers and need to be accommodated near the equipment, typically hung on the wall or the machine itself, usually becoming an encumbrance. The proposed automatic equipment for production of ice cream is equipped with a place for the cone and cup holders, without the need to take up any additional space, resulting in a nicer and cleaner look.

Cabinet in the Front Portion of the Machine

At the end of the productive period of the day a few parts of the machine must be disassembled, sanitized and stored in a dry and safe place. They must be reassembled in the equipment only a few moments before starting production, to prevent the formation of mold and other sanitary inconveniences. In conventional machines, this storage is usually done in cabinets close to the machine, most of the times without the necessary hygiene requirements.

The proposed automatic equipment for production of ice cream has a glass door on the front face, which includes a 100% hygienic cabinet where the disassembled parts can be stored separately, with total safety and hygiene. The glass door still allows placing a sticker with the logo of the company or a desired art, making the equipment and the business more attractive.

Innovative Cleaning System

In conventional machines it is necessary to use a bucket in front of the machine to wash the mixture containers and the freezing cylinders. In addition, the cleaning water from the containers can only flow out through the freezing cylinders.

In the automatic equipment for production of ice cream, the containers may be washed separately from the cylinders and the water drain is in the rear of the machine, with a direct connection to the collection system of the installation. Likewise, the freezing cylinders can be washed separately from the containers, with water runoff also on the rear of the machine in a direct connection to the collection system. The possible drops of ice cream or excesses in the extraction process can be washed automatically with a water spray positioned at the ice cream output, with runoff also on the rear of the equipment.

Innovative Design

The automatic equipment for production of ice cream has a significant innovative design, thus eliminating the concept that the ice cream machine must be coated with ornaments and publicity so that it does not appear, since its structure is little appreciable, clumsy and not very hygienic.

The machine can be equipped with a motorized system for raising or lowering the entire machine, allowing easy access to refuel the containers or regulate the best working height for the operator.

The automatic equipment for production of ice cream has an innovative structure based on aircraft technology, its front and rear have plates without apparent bolts, it is self-structured and has an acoustic isolation, which provides a low noise level.

Just as formula one cars, the machines resistance is superior to steel, its weight is much lower and can be painted in several colors.

There is also the option of full glass on the front or stainless steel. The panel is made out of tempered glass, is customizable, with “soft touch” buttons on the glass, and can be washed entirely with a jet of water.

Who is it for

For places of business of various branches, which have high circulation of persons, on which ice cream can be impulse bought.

Pharmacies, bakeries, bookstores, ice cream shops and various other types of shops can easily put such a machine in front of the establishment, with a simple operator training.

Its innovative design, its technical characteristics, the high quality ice cream produced by the automatic equipment for production of ice cream, and how it is presented meet even the most demanding upper class consumer market requirements.

Hence the equipment described is simple in its construction, therefore it is easily feasible, and yields excellent practical and functional results, while offering an innovative construction when compared to existing designs.

The machine was idealized with an innovative design, resulting in a harmonious machine with unusual but effective characteristics, standing out in constructive aspects, versatility and ease of use.

### BRIEF DESCRIPTION OF THE FIGURES

For better understanding on what constitutes the “DISPOSITION INTRODUCED IN AUTOMATED EQUIPMENT FOR THE PRODUCTION OF ICE CREAM”, which is hereby requested, are illustrative drawings annexes:

FIG. 1—Shows the frontal superior perspective view of the automatic equipment for production of ice cream.

FIG. 2—Shows the frontal inferior perspective view of the automatic equipment for production of ice cream.

FIG. 3—Shows the back superior perspective view of the automatic equipment for production of ice cream.

FIG. 4—Shows the frontal superior perspective view of the automatic equipment for production of ice cream with the top open.

FIG. 5—Shows the frontal superior exploded view of the automatic equipment for production of ice cream.

FIG. 6—Shows the frontal inferior perspective view of the interior of the machine, where one can observe the ice cream output with the four different shapes that conform the ice cream.

FIG. 7—Shows the back superior perspective view of the interior of the automatic equipment for production of ice cream, where one can observe the freezing cylinders.

FIG. 8—Shows the frontal superior perspective view of the automatic equipment for production of ice cream without the chassis front frame and without the cover of the freezing cylinders.

FIG. 9—Shows the frontal superior perspective view of one agitator unit with heating and cooling of the automatic equipment for production of ice cream.

FIG. 10—Shows the frontal superior perspective view of one agitator unit with heating and cooling without the external pipe.

FIG. 11—Shows the frontal superior perspective view of one agitator unit with heating and cooling without the concentric tubes, where one can observe the helicoid that makes the agitation.

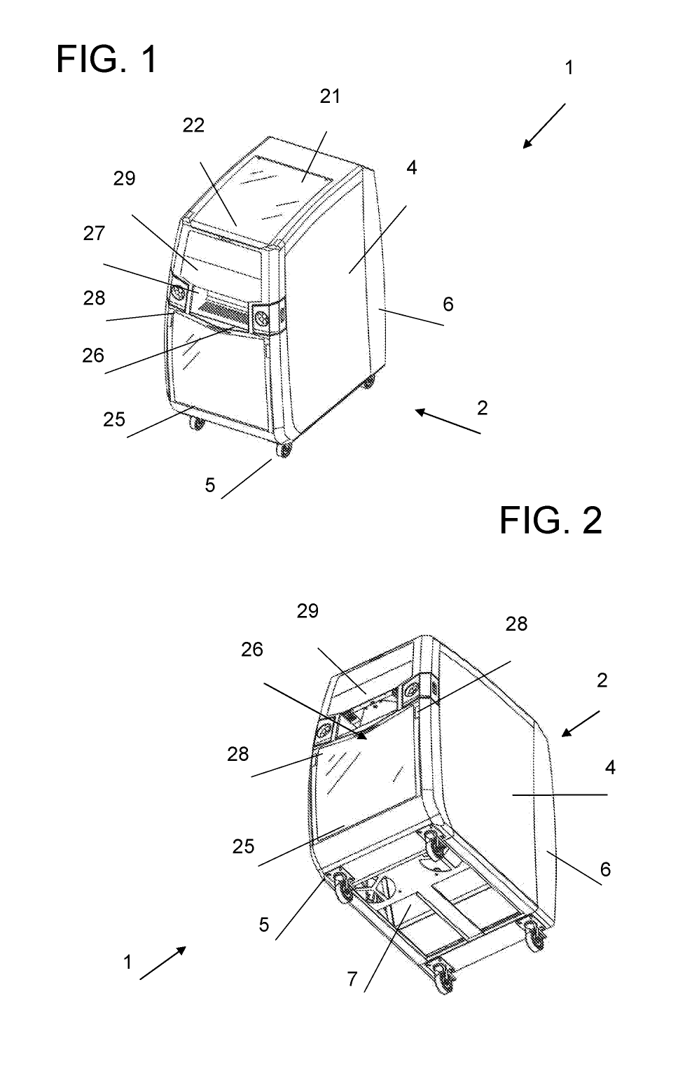

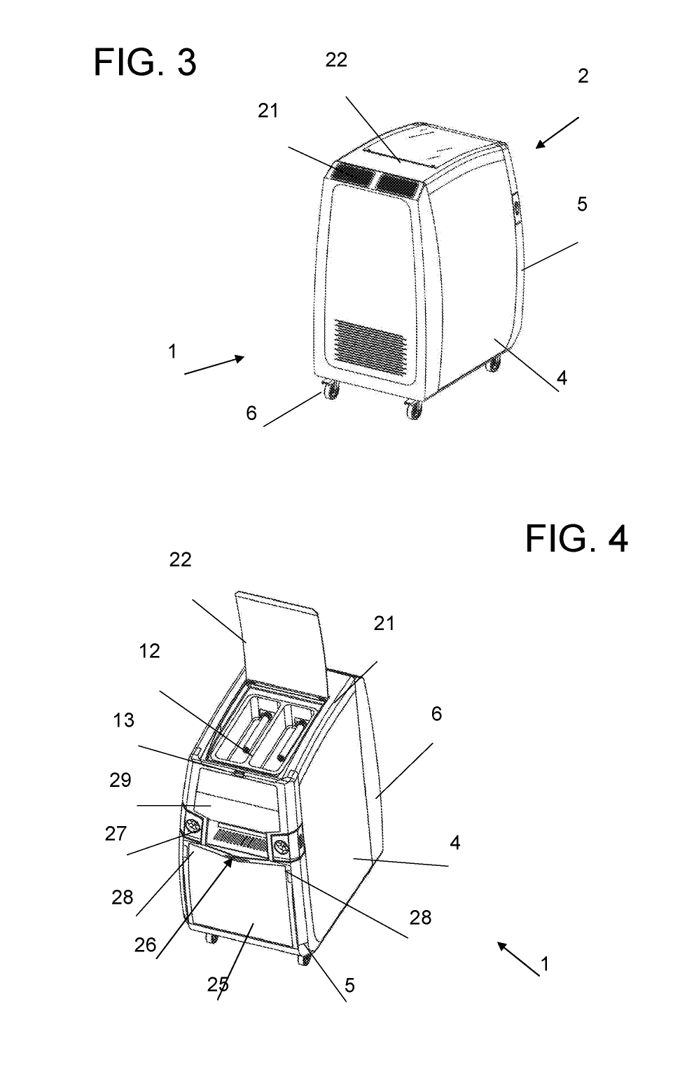

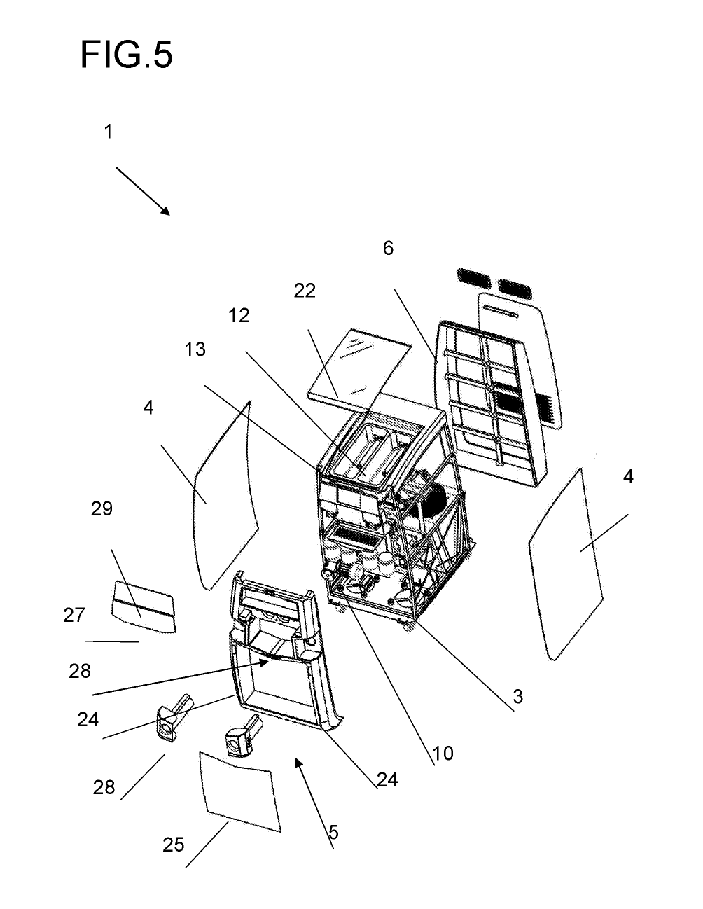

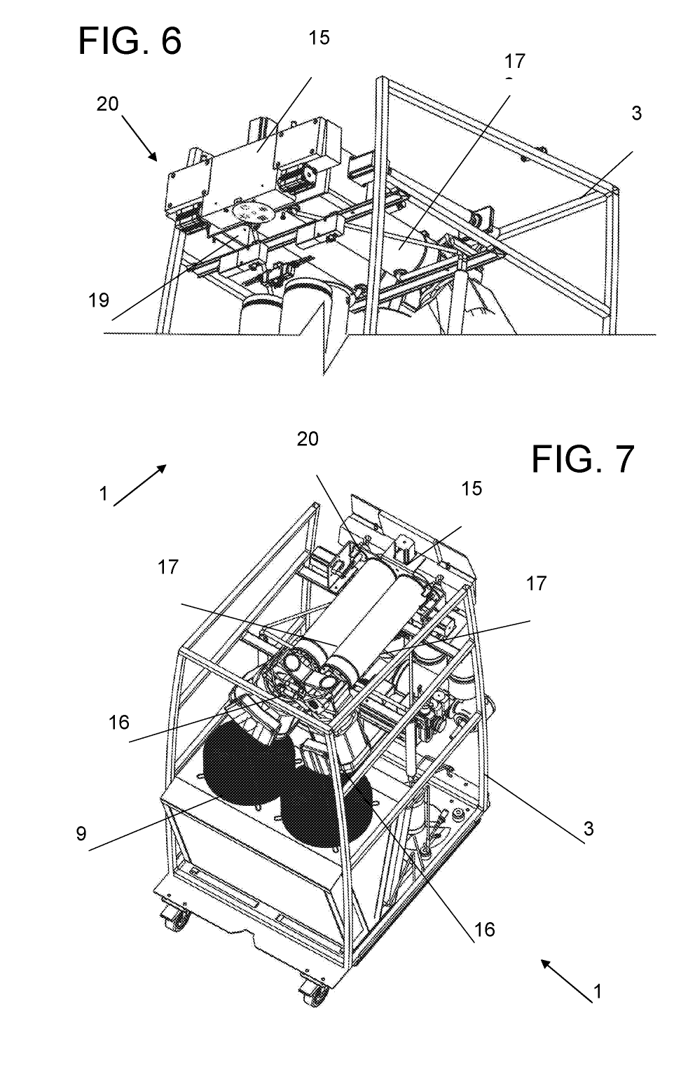

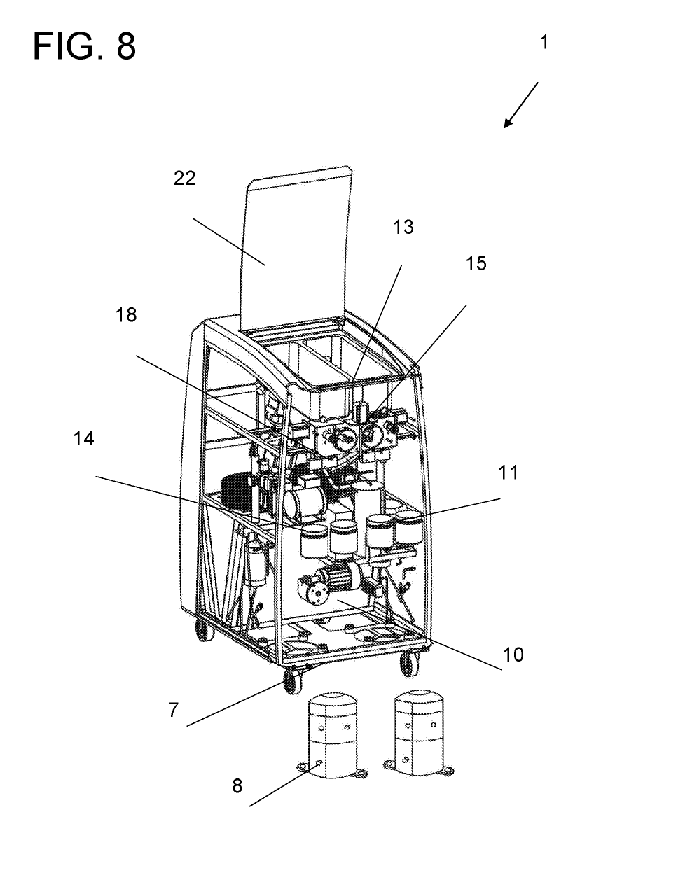

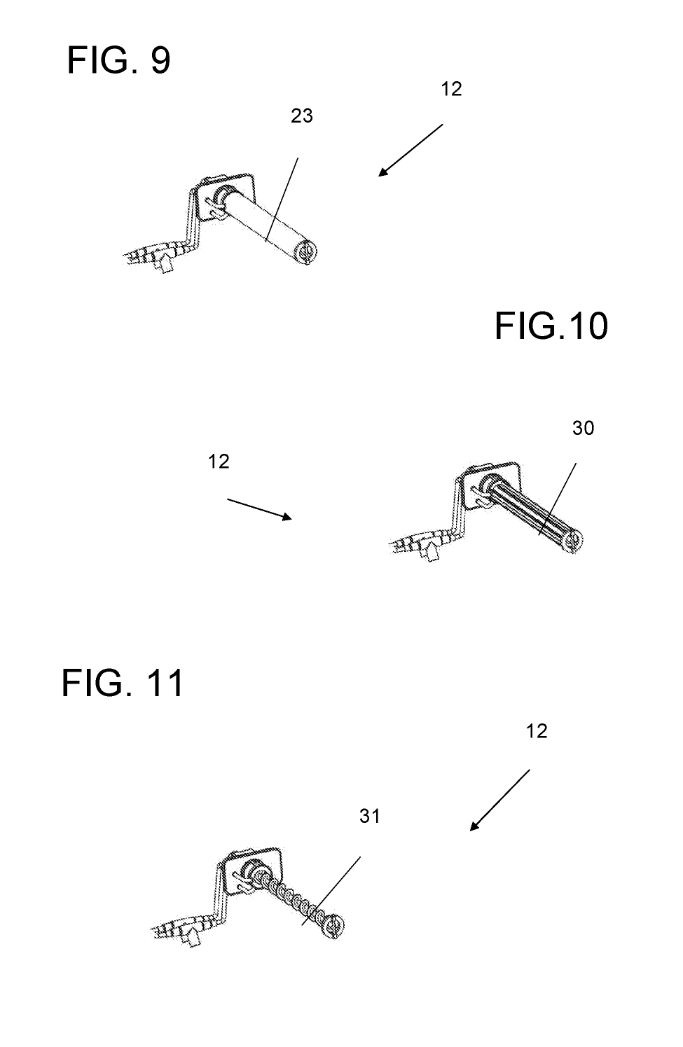

### DETAILED DESCRIPTION OF THE EMBODIMENTS

In accordance with the concepts illustrated the related figures above, the “DISPOSITION INTRODUCED IN AUTOMATED EQUIPMENT FOR THE PRODUCTION OF ICE CREAM”, object of this patent, refers to an innovative model of automatic machine for production of “soft” ice cream.

The automatic equipment for production of “soft” ice cream (1) is made up from a casing (2) with a vertical rectangular prismatic geometry comprised by a structural frame (3) assembled with square profiles and smooth stainless steel panels (4). The front receives a structural frame (5) in glass fiber, the back also receives a structural frame (6), however with different conformation and the lower face has a perforated plate (7) that allows the passage of air to the condensers and still allows the adaptation of the lifting and declining system (optional).

Internally, in the lower portion of the casing (2), are positioned one or two refrigerant compressors (8), one or two air condensers (9) and the colored syrup injection system (10). Above these are installed the glycol heating, cooling and pumping unit (11), used in the agitators (12) for heating and cooling the ice cream mixtures contained in the containers (13) and a compressed air unit (14) responsible for driving outlet/dosage valves of the ice cream and by the injection of air in the freezing cylinders. Above these are installed two cylinders (17) involved by a freezing system and coupled to gear motors to do the mixing and incorporation of air on the ice cream and the piston pumps (18) that receive the ice cream mixture from the containers (13) to pump into the cylinders. On the front of the cylinders is the shape swivels (19) driver system (15) that enables the change of the ice cream extraction shape.

Above the aforementioned freezing cylinders (17) are positioned two containers (13), sustained by a fiberglass support (21), which has a pivoting curved glass cover (22). The support (21) has drainage channels for the fluid that precipitates on the cover to guide the fluid to the back of the machine.

The containers (13) are tilted forward and the outputs of the mixtures are in the front on the machine directly to the pumps, also positioned in the front of the casing (2).

Internally, at each container (13) there is an agitator (12) for cooling and heating composed by two concentric tubes, the external (23) and the internal (30). In between the tubes is pumped hot or cold glycol and in the internal tube (30) there is a helicoid (31) to agitate the mixture.

The cover of the freezing cylinders (20) comprises the heads of the mixture pumps, the air inlet system, which is independent of the mixture, and the single holed ice cream output system. After the output hole there is a shape swivel (19) which changes the shape of the ice cream output. The same hole can output two flavors of ice cream, separate or mixed. Flavored syrup can be added to each flavor. The cover of the freezing cylinders (20) comprises two pistons to push ice cream to a single ice cream output.

The structural frame (5) in the front is constituted by two side columns (24), where the bottom half has a glass door (25) which closes a cabinet that stores various materials and in the top half there is a rectangular compartment (26) for the extraction and decoration of the ice cream. On each side of the aforementioned compartment (26) there is a cylindrical compartment (28) for storing containers for serving ice cream (cups or cones). Above these compartments, the face is covered by a stainless steel plate (27) and above the plate, there is a “soft touch” glass control panel (29).

In this descriptive report of a new conception in automated equipment for the production of ice cream were presented, demonstrated by the analysis carried out and by the figures shown, numerous differences to conventional models existing in the consumer market, such as constructive and functional technical characteristics that are completely different from the state of the art. Because of the advantages which the disposition offers, and also because of the truly innovative characteristics of the machine which fulfill all the requirements of novelty and originality in the area, this “DISPOSITION INTRODUCED IN AUTOMATED EQUIPMENT FOR THE PRODUCTION OF ICE CREAM” meets the necessary conditions to deserve a utility model patent.

1) DISPOSITION INTRODUCED IN AUTOMATED EQUIPMENT FOR THE PRODUCTION OF ICE CREAM, also called automatic equipment for production of “soft” ice cream (1) is made up from a casing (2) with a vertical rectangular prismatic geometry, in which internally are positioned the refrigerant compressors (8) and other components for the production of the ice cream. The cover of the freezing cylinders (20) comprises the heads of the mixture pumps, the air inlet system, which is independent of the mixture, and the ice cream output, characterized by the fact that the ice cream output is composed by a single orifice with a shape swivel (19), which changes the shape of the ice cream output, that can extract two flavors of ice cream, separately or mixed, and add flavored syrup to the ice cream. The cover of the freezing cylinders (20) also comprises two pneumatic pistons to a single ice cream output to allow or block the flow of ice cream depending on which flavor should be extracted. Above the freezing cylinders (17) are positioned two containers (13), each equipped with an agitator to heat and cool the mixture, composed by two concentric tubes, the external tube (23), the inner tube (30) and a coaxial helicoid (31) actuated by a gear motor. The structural frame (5) in the front is constituted by two side columns (24), where the bottom has a glass door (25) which closes a cabinet that stores various materials and in the top half there is a rectangular compartment (26) for the extraction and decoration of the ice cream. On each side of the aforementioned compartment (26) there is a cylindrical compartment (28) for storing containers for serving ice cream (cups or cones), above these compartments there is a stainless steel plate (27) that covers the freezing cylinder cover (20) and above the plate there is a “soft touch” glass control panel (29).
